(19) United States
(12) Patent Application Publication
(10) Pub. No.: US 2006/0154228 A1
(43) Pub. Date: Jul. 13, 2006

(54) Computer Forced Focus on Training Material

(76) Inventor: Raymond Donald Schrab, Hartford, WI (US)

Correspondence Address: Raymond D. Schrab, 6536 Hawthorne Lane, Hartford, WI, 53027, US

(21) Appl. No.: 10/905,612

(22) Filed: Jan. 12, 2005

(51) Int. Cl. G09B 19/00; G09B 25/00

(52) U.S. Cl. 434/365; 434/236

(57) ABSTRACT

The invention consists of a computer program useful for training people over the internet, or other computer networks. This program resides on a server computer and upon the selection of a link to the file which contains it, will download to the client computer. This program will create a text document which will record the travel of the mouse cursor over the face of the document in a way which mimics the reading of a printed page by pointing one's finger at the words being read. The program will record the percentage of the page covered by the mouse cursor, and therefore closely focused upon by the trainee. It will send that data back to the web server for posting to a database under the log-in identifier of the trainee. The program contains algorithms which prevent the recording of the mouse cursor movement if the movements are random motions, right to left, too fast, or otherwise in a pattern indicating the material is not being read. The invention can also be used to record the thorough review of material contained in an image, such as a graph or illustration.

### FIELD OF THE INVENTION

The invention is a computer program which calculates the percentage of training material which has been carefully reviewed or read by the user of a computerized training system. It is useful for the training of people over the internet or other computer networks.

### BACKGROUND OF THE INVENTION AND PRIOR ART

The internet, other computer networks, and computers in general, have proven powerful tools for presenting training material to people, especially to those located at many different remote locations. Programs and web sites which do this contain the ability to display documents and images which have been selected by the user from a menu which is linked to those documents and images.

The present invention addresses the shortcomings of the mere presentation of text or image documents on a computer screen. While previous systems display the material on the screen, there is no way to know if the user focused on the material to any degree, or even kept the screen open for more than a second or two. In many cases, there is no way for a trainee's supervisor or training administrator to know if the trainee used the system to display the material at all. The present invention allows the trainee's supervisor or training administrator to determine if the trainee displayed the material, and to what degree the trainee focused on the material.

### SUMMARY OF THE INVENTION

Operation of the invention begins when a trainee logs in to the computer program using a user identifier, along with a password if deemed appropriate. This allows subsequently recorded information to be sent back to the server for filing in a database by trainee.

The invention is a computer program which will select a text document file from a computer network server, exemplified by an internet web server, and determine the size of the text document contained in the file. The invention will then combine a separate computer program with the text document file and send the result to the client computer screen. The result will be a display area, adjusted to the size of the text document, and broken down into small invisible rectangular grids. Those invisible grid areas will be cover the same area of the computer screen as the visible text document.

The computer program sent to the client computer along with the text document will detect the movement of the mouse cursor over the invisible grid areas, and therefore also over the lines of the text document. Algorithms contained in the program will determine if the mouse cursor movement is consistent with movement analogous to the motion of one's finger across the page of a book, when reading in that fashion. Areas of text contained in rectangles of the grid, which are covered by the mouse cursor in a manner accepted by the algorithms, will be considered attentively read. If the mouse cursor enters a grid rectangle from a direction, or at a speed, inconsistent with a focused reading of the text, that motion will be ignored and the text corresponding to that grid area will be considered not attentively read.

After the trainee feels he or she has adequately covered the material presented in the text document, the document will be closed. At that time the total number of rectangular grid areas associated with the document will be counted. Also counted will be the number of grid areas attentively focused on as indicated by appropriate motion of the mouse cursor over each grid area. That second number of grid areas, divided by the total number of grid areas as first calculated, will determine the percentage of the document considered attentively read.

The percentage of the document considered read will be sent back to the server for recording in a database, under the user identifier. This will allow the trainee's supervisor or training administrator to review the performance and effort of the trainee in attentively reviewing the training material presented.

### BRIEF DESCRIPTION OF THE ILLUSTRATIONS

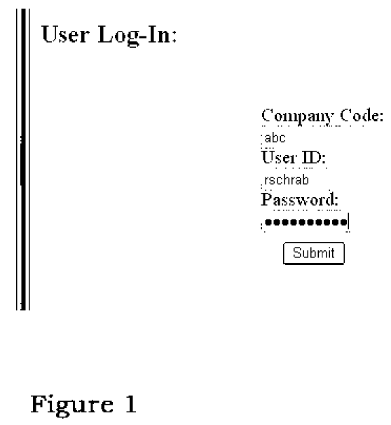

FIG. 1. User identifier entered into the system at log-in time.

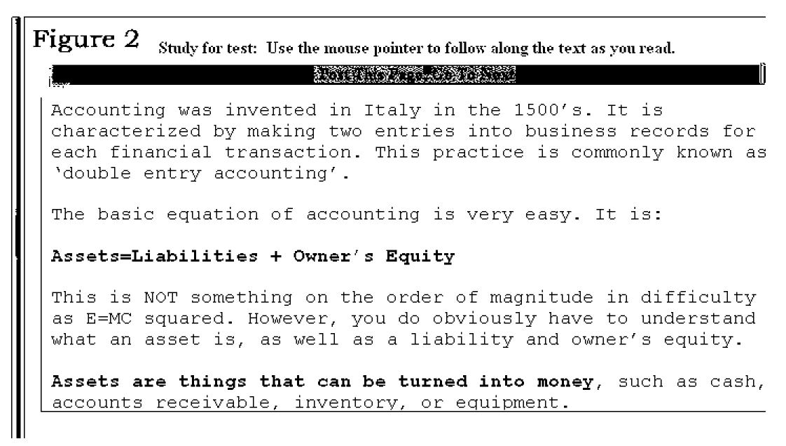

FIG. 2. Text document as displayed by the program on the client computer.

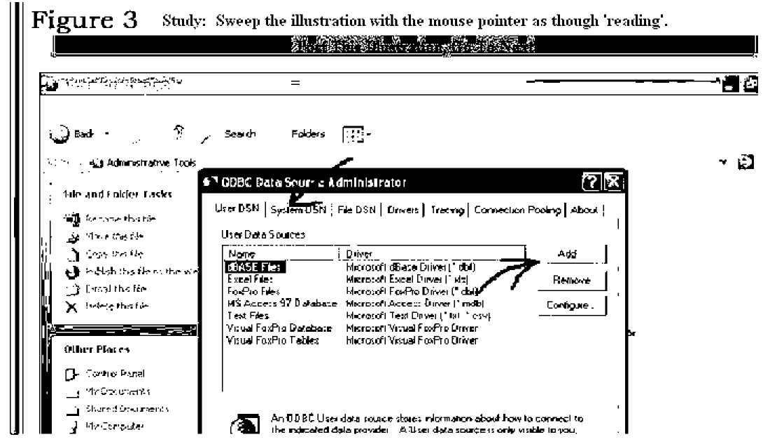

FIG. 3. Image document as displayed by the program on the client computer.

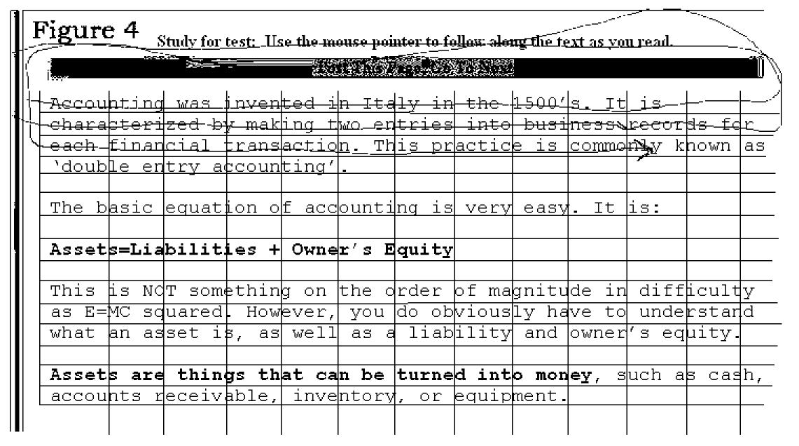

FIG. 4. Example of mouse cursor movement which will be recorded as a focused effort, indicating attentive reading or review of the material presented.

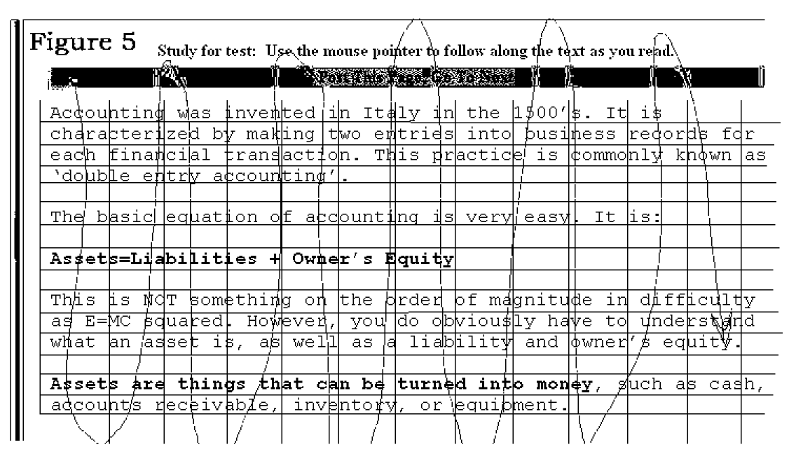

FIG. 5. Example of mouse cursor movement which will be ignored, and not recorded as a focused effort to read or review the material presented.

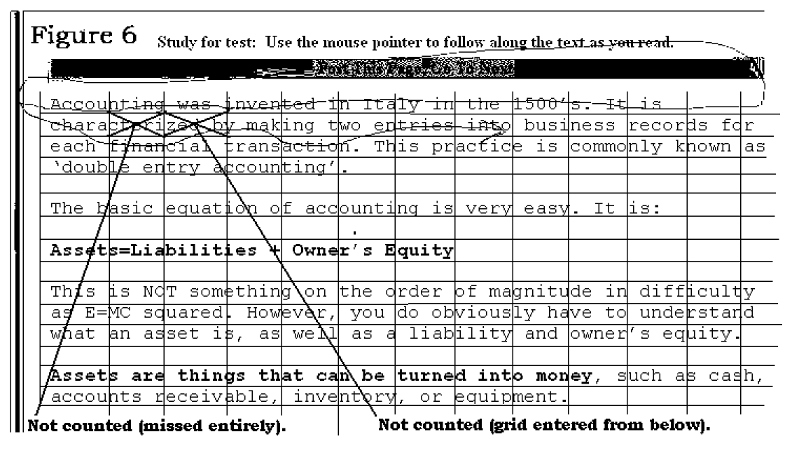

FIG. 6. Another example of mouse cursor movement which will be ignored.

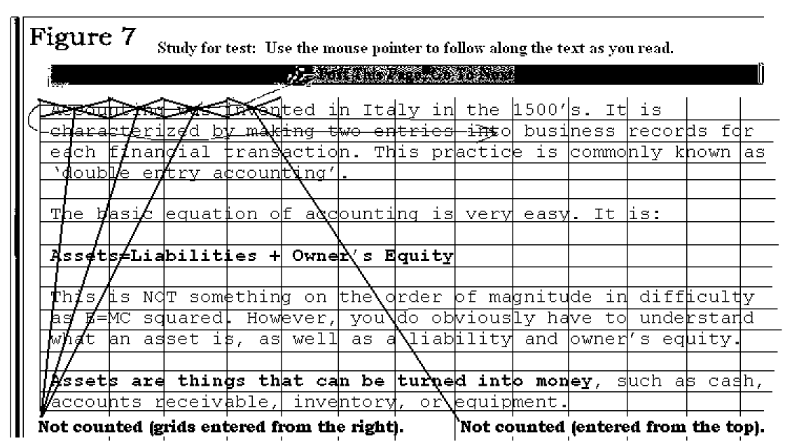

FIG. 7. Another example of mouse cursor movement which will be ignored.

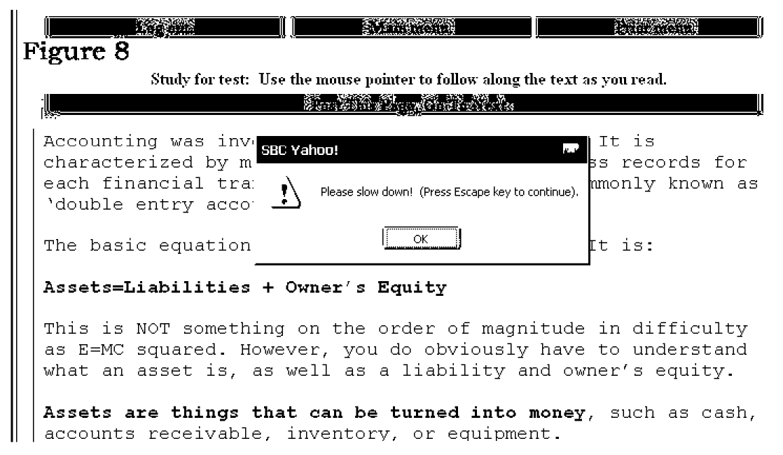

FIG. 8. Example of message box displayed when mouse cursor movement is too fast.

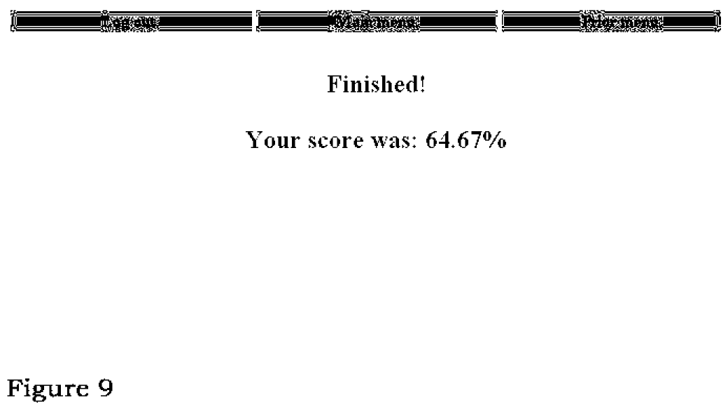

FIG. 9. Display of results of the trainee effort, to be sent back to the server for recording in a database.

### DETAILED DESCRIPTION OF THE INVENTION

The invention entails a computer network, and a computer program running on a server in that network. A user at a client computer on the network will log into the program running on the server. Access to the program on the server will be controlled via a user id and password, in order to prevent unauthorized use of the training system, or unauthorized viewing of any confidential training material.

FIG. 1 illustrates the user id and log-in control. In this embodiment there is a third control field called a Company Code. It identifies the company or department the user belongs to.

The trainee then navigates to the text to be studied, via a menu system. Once there, the text is displayed by the invention, which is a computer program on the server which opens the file containing the text and determines it's size, then downloads the text and a special accompanying program to the client computer. The program now downloaded to the client computer displays the text in an appropriately sized area which will also contain invisible grid areas.

FIG. 2 illustrates how the text appears in the display area.

The same process is used by the program to display an image to be studied. Such images can be used for graphs, drawings, or illustrations.

FIG. 3 illustrates how an image appears in the display area.

The trainee then sweeps the mouse cursor over the displayed text, from left to right, and slowly enough to indicate attentive reading of the material. Algorithms included in the program downloaded to the client computer will analyze the path of the mouse cursor, and determine if they follow a path which indicates an attentive reading of the displayed text. The algorithms are such that a significant amount of concentration must be used, and attention closely focused on the lines on the page. Such focus and concentration will bring the content of the text line to the attention of the user and result in recognition and some recording to the user's memory, of the written text. In one embodiment, if the motion of the mouse is too fast, an error message will pop up which will prevent the user from continuing. The user will have to close the error message display before being allowed to move on at a slower pace.

FIG. 4 illustrates the path followed by the mouse cursor which will result in successful recording as attentive reading of the grid areas covered. The grid lines as shown are not visible to the user. These are meant to indicate where the invisible grid lines mark off the grid areas which the mouse cursor must cross following a path from left to right.

If the mouse cursor covers the grid areas in random patterns, or patterns not found in a normal reading process, such as up and down, the grid areas covered will not be counted as attentively read.

FIG. 5 illustrates a pattern covering grid areas which will not be recorded as attentively read, because they are random motions up and down across the page. Any grid area entered from either the top or the bottom, will not be counted as attentively read.

If the mouse cursor does not enter a grid area at all, that grid area will not be recorded as attentively read.

FIG. 6 illustrates a mouse path which misses a grid area. That area will not be counted as attentively read. This figure also illustrates a grid area not counted because the mouse cursor entered it from below.

If the mouse cursor enters a grid area from the right, that grid area will also not be counted as attentively read.

FIG. 7 illustrates a path from right to left. Grid areas entered from the right will not be counted as attentively read. This figure also illustrates a grid area not counted because the mouse cursor entered it from the top.

If the mouse cursor is being moved over the grid areas too quickly, the algorithm in the program will recognize that the trainee is not reading the text. A message box will be displayed asking the trainee to slow down. The message box will need to be closed before the trainee can continue moving the mouse cursor. That will prevent the trainee from simply quickly sweeping the mouse cursor over the displayed text and pretending they are reading or reviewing the material.

FIG. 8 illustrates the message box which advises the trainee to slow down. It also prevents them from continuing until the message box is closed, either by pressing the ‘Escape’ key or clicking ‘OK’.

After the text area is thought to be covered, the trainee will click on a menu button which will ‘submit’, or send, the results recorded by the program running on the client computer back to the server computer. The results include the total number of grid areas in the text display, as well as the number of grid areas successfully recorded as attentively read. The latter divided by the former results in the percentage the trainee has scored on the study of the given text document. The result sent will be displayed for the trainee's benefit. The same data will then be recorded in a database on the server for later retrieval and review by the trainee, supervisors, and training administrators.

FIG. 9 illustrates the message showing the trainee the result of his effort to attentively read the displayed text.

A program such as the one described above, will also be used in conjunction with an image file downloaded to the client computer and displayed to the user. Although in most cases an image file will not contain a text document, it can still be covered by a careful ‘sweeping’ of the display area by the mouse cursor. Close attention and focus will need to be given to keep the mouse cursor on a path acceptable to the algorithms included in the program. Again, such focus and attention will result in user recognition of the material presented in the image, and some recording of that material in the user's memory. Again, the number of grid areas present, and successfully covered, will be recorded by the program. A score will be calculated, displayed to the user, and sent back to the server computer for recording in a database.

What is claimed is:

1. A computer aided training mechanism comprising a program downloaded from a server computer to a client computer, which brings with it and displays a text document in a display area which correlates to the location of invisible grid areas laid out on the computer display screen, and a programmed capability to recognize when the trainee has moved the mouse cursor over the grid areas in a way which indicates that the trainee is focusing carefully upon, and therefore cognizant of the material presented in the text document.

2. A computer aided training mechanism comprising a program which will determine when the mouse cursor was moved over the various grid areas mentioned in claim 1, by the trainee in a pattern consistent with a careful reading of the document in a manner similar to the reading of a printed document while pointing one's finger at the words being read, and determining over which grid areas the mouse cursor moved in a strictly controlled and non-random pattern, indicating a close focus of the trainee on the given grid areas and resulting cognizance of the text co-located with the said grid areas.

3. Additional computer programming comprising the capability to recognize when the trainee is moving the mouse cursor over the grid areas referred to in claim 1 too quickly to allow the trainee to carefully read the words of the text co-located with the grid areas, and a programmed popup message which will advise the trainee of this and force movement of the cursor to stop until this message is acknowledged, and will force further movement of the cursor to be at a slower speed.

4. Additional computer programming comprising the results of the program capability in claims 1, 2, and 3 being recorded as areas of the text focused upon, versus those not focused upon, as well as the total area of the text document, and the recording of the percentage of the document focused upon, all of which are useful to the trainee, as well as the trainee's supervisors and training administrators, in determining the degree of effort and focus the trainee has exerted in reviewing the training material.

5. Additional computer programming comprising the ability to use the capabilities mentioned in claims 1, 2, 3, and 4 with material presented as an image.
